(19) United States
(12) Patent Application Publication
(10) Pub. No.: US 2026/0267361 A1
(43) Pub. Date: Sep. 10, 2026

(54) PUMP MONITORING AND CONTROL SYSTEM

(71) Applicant: S.J. Electro Systems, LLC, Detroit Lakes, MN (US)

(72) Inventor: Joshua Robert Kertscher, Frazee, MN (US)

(73) Assignee: S.J. Electro Systems, LLC, Detroit Lakes, MN (US)

(21) Appl. No.: 19/556,035

(22) Filed: Mar. 4, 2026

Related U.S. Application Data
(60) Provisional application No. 63/767,744, filed on Mar. 6, 2025.

(51) Int. Cl. G05D 7/06; G06K 19/06

(52) U.S. Cl. CPC G05D 7/0676; G06K 19/06037

(57) ABSTRACT

The present disclosure provides one or more examples of a pump monitoring system and method for retrieving logged data. In examples, the present disclosure provides a submersible pump system having a data log and a pump controller. The pump controller receives pump sensor data and stores the pump sensor data in the data log. The system further provides a dynamic code generator that upon receiving a data request, dynamically generates a code representative of the pump sensor data stored in the data log, where the code is a readable code. In one example, the system is a submersible pump monitoring and control system. In another example the disclosure includes a method of operating a submersible pump system.

### BACKGROUND

The present disclosure relates generally to examples of data systems and methods, including a system and method for logging data and for reading the logged data.

Known pump monitoring systems require the need for removable electronic storage media on the controller device to view, manipulate or transfer the data to and from a PC, or specialized equipment that can read the data and transfer it to another device. Removable storage media can be lost or damaged in the transportation of the storage media to an office or other location where viewing of the data is done. Specialized equipment necessary to read the data can be expensive or, if damaged, make reading data impossible until replacement equipment can be obtained. Often times specialized equipment is not suitable for use in outdoor environments.

In a submersible pump installation, removable storage media can easily be lost, dropped, or damaged due to the often harsh submersible pump environments.

There is a need for a low cost, easy to use, and easy to implement solution for a way to transfer logged data to transfer for use by a customer for customer service, troubleshooting, or record keeping and maintenance purposes.

For these and other reasons, a need exists for the claimed subject matter.

### SUMMARY

The present disclosure provides one or more examples of a pump monitoring system and method. In examples, the present disclosure provides one or more examples of a pump monitoring system for logging data including dynamic code generation representative of the logged data.

In one example, the system is a pump monitoring system. The pump monitoring system can be a submersible pump monitoring system. The pump monitoring system includes a data log. A pump controller receives pump sensor data and stores the pump sensor data in the data log. A dynamic code generator is provided that, upon receiving a data request, dynamically generates a code representative of the pump sensor data stored in the data log, where the code is a multidimensional readable code.

Another example includes a submersible pump monitoring system. The system includes a data log and a pump display. A pump controller receives pump sensor data and stores the pump sensor data in the data log. The system further includes a dynamic code generator, where upon receiving a data request, dynamically generates a QR code representative of the pump sensor data stored in the data log, and outputs the QR code to the pump display.

Another example provides a method retrieving submersible pump monitoring system data. The method includes providing a data log and a pump display. The method further includes receiving pump sensor data and storing the pump sensor data in the data log. The method provides for dynamically generating a QR code representative of the pump sensor data stored in the data log, and outputting the QR code to the pump display.

Additional and/or alternative features and aspects of examples of the present technology will become apparent from the following description and the accompanying drawings.

### BRIEF DESCRIPTION OF THE DRAWINGS

The Figures generally illustrate one or more examples of a pump monitoring system and method, including dynamic code generation for retrieving of logged data.

FIG. 1 is a diagram illustrating one example of a pump monitoring system including a dynamic code generator.

FIG. 2 is a diagram illustrating one example of a display for use with the system illustrated in FIG. 1.

FIG. 3 is a diagram illustrating one example of a method of retrieving logged data from a pump monitoring system.

FIG. 4 is a diagram illustrating one example of the method of FIG. 4.

FIG. 5 is a diagram illustrating one example of a submersible pump monitoring system including a dynamic code generator.

FIG. 6 is a diagram illustrating one example of a display used in the submersible pump monitoring system of FIG. 5.

FIG. 7 is a diagram illustrating one example of a submersible pump installation including a pump monitoring system.

FIG. 8 is a diagram illustrating one example of a submersible pump installation.

FIG. 9 is a diagram illustrating one example of a display used in a pump monitoring system.

FIG. 10 is a diagram illustrating one example of a control panel used in a pump monitoring system.

FIG. 11 is a diagram illustrating one example of a removable display in communication with the control panel of FIG. 10.

FIG. 12 is a diagram illustrating one example of a method of retrieving logged data from a pump monitoring system.

FIG. 13 is a diagram illustrating one example of a method of retrieving logged data from a pump monitoring system.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

The term QR code, as used herein, is a registered trademark of DENSO WAVE INCORPORATED. The term “dynamically” generated code is defined as a code being immediately generated that contains the present state of the logged data. The code is dynamically generated upon receipt of a data request or upon occurrence of a predefined event that triggers dynamic generation of a code. One example condition is upon occurrence of an alarm condition or sensor failure a code is immediately dynamically generated and displayed.

### Dynamic QR Code Generation for Logged Data

The present disclosure provides one or more examples of a system and method for logging data. In examples, the present disclosure provides one or more examples of a system for logging data including dynamic code generation representative of the logged data.

In one or more examples, the system consists of a programmable controller, a graphic display/user interface and one or more sensors. The controller is programmed to perform a function, including logging data, based on the status of the connected sensors. System and method examples is illustrated in the drawings an detailed herein.

The controller can keep track of information pertaining to the sensors (e.g., pump sensors, switches, detectors, and alarms), as well as the devices that are being controlled. Sensor data can include each sensor's measurement at set time intervals, sensor out of range events or failed sensor events or alarm data.

Controlled device data can include the accumulated number of device activations, the accumulated time that a device has been activated, or failed device events. All this information can be helpful in troubleshooting or diagnosing existing problems in a system. Historical data that is stored on a controller and available to a user can also be helpful in predicting the potential for a problem to arise in the future, which can be mitigated by providing preemptive maintenance of the system.

The controller may also have configuration settings that are useful to know when troubleshooting or diagnosing problems in the system. This can be user adjustable levels of measured sensor data that triggers an action to a connected device, such as turning on a pump when the water in a tank gets to user configured level. Having access to a multitude of user settings can greatly decrease the time to find potential errors in the initial setup of a system.

To ensure the user has easy access to the stored data on the programmable controller, a code is dynamically generated when the user accesses the function in the graphic display/user interface. A code can also be immediately generated upon occurrence of a predefined event, such as an alarm or device fail condition. In one example, the code is a QR code. Since the data may include date and time stamps for events that are logged, the controller is able to generate a new QR code every time the function is accessed. The QR code stores the logged data. The user is then able to use a device such as a display reader (e.g., a smart phone or tablet) to “scan” the QR code shown on the system's display/user interface. Once scanned, the smart phone or tablet can decode the QR code into a text file, which can be viewed or electronically transmitted to other users.

The benefit of the QR code is that it negates the need for removable electronic storage media on the controller device to view, manipulate or transfer the data to and from a PC, or specialized equipment that can read the data and transfer it to another device. Removable storage media can be lost or damaged in the transportation of the storage media to an office or other location where viewing of the data is done and specialized equipment to read the data can be expensive or, if damaged, make reading data impossible until replacement equipment can be obtained.

### Dynamic QR Code Generation for Pump Monitoring Applications

In examples, the system is a pump monitoring system. In one example, the system is a submersible pump monitoring and control system. The pump monitoring system consists of a programmable controller, a graphic display/user interface and one or more electric motors and pump sensors. The controller is programmed to monitor the internal high temperature switch of a pump motor, as well as the pump's seal leak sensing probes. The pump monitoring controller is used to notify a user when there is a problem or future problem with a pump or pump motor. Once notified of a potential problem, the user can take action to provide maintenance on the pump or pump motor.

The controller monitors the motor and pump sensors. Sensor data includes each sensor's measurement at set time intervals, sensor out of range events, abnormal sensor data, or failed sensor events or alarms. The pump monitor controller data includes the accumulated number of pump activation events, the accumulated number of pump high temperature or seal failure events, the accumulated time that the pump monitor controller has been activated, the accumulated time that a pump has operated, and a log of anytime a setting has been changed. All this information can be helpful in troubleshooting or diagnosing existing problems in a pumping system. Historical data that is stored on the pump monitor controller and available to a user can also be helpful in predicting the potential for a problem to arise in the future, which can be mitigated by providing preemptive maintenance of the pump or pumping system.

The pump monitor controller may also have configuration settings that are useful to know when troubleshooting or diagnosing problems in the system. These can be user adjustable abnormal sensor levels which trigger an action of a connected device, such as turning on a pump when the water in a tank gets to user configured level, disabling a pump if a high temperature in the pump's motor housing is sensed, or turning on an indicator that notifies a user that there is water leaking past the seal in a pump housing. Having access to a multitude of user settings can greatly decrease the time to find potential errors in the initial setup of a system.

To ensure the user has easy access to the stored data on the programmable controller, a code is dynamically generated when the user accesses the function in the graphic display/user interface. In one example, the code is a QR code. Since the data may include date and time stamps for events that are logged, the controller must be able to generate a new QR code every time the function is accessed. The QR code stores the logged data. The user is then able to use a device such as a smart phone or tablet to “scan” the QR code shown on the system's display/user interface. Once scanned, the smart phone or tablet can decode the QR code into a text file, which can be viewed or electronically transmitted to other users.

The benefit of the QR code is that it negates the need for removable electronic storage media on the controller device to view, manipulate or transfer the data to and from a PC, or specialized equipment that can read the data and transfer it to another device. Removable storage media can be lost or damaged in the transportation of the storage media to an office or other location where viewing of the data is done and specialized equipment to read the data can be expensive or, if damaged, make reading data impossible until replacement equipment can be obtained.

The Figs. generally illustrate one or more detailed examples of a pump monitoring system and method, including dynamic code generation for retrieving of logged data.

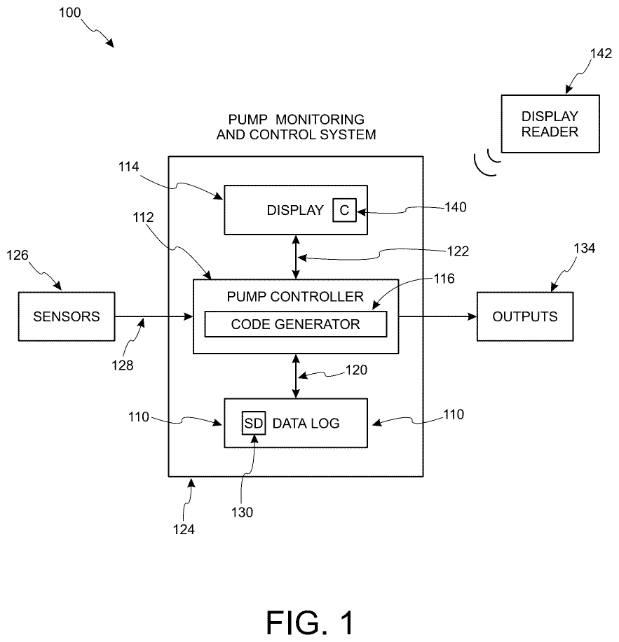

FIG. 1 is a diagram illustrating one example of a pump monitoring and control system including a dynamic code generator generally at 100. In one example, the pump monitoring and control system 100 is a submersible pump monitoring and control system. Although the pump monitoring and control system 100 as detailed herein may be referred to as a pump monitoring system, it is recognized that the system 100 may be a pump monitoring system, a pump control system, or both a pump monitoring system and a pump control system.

The pump monitoring system 100 includes a data log 110, a pump controller 112, and a display 114. The pump controller 112 further includes a code generator 116. In one example, code generator 116 is a dynamic code generator. In one or more examples, the pump controller 112 is a logic controller. The data log 110 is in communication with the pump controller 112, indicated at 120. Display 114 is in communication with the pump controller 112, indicated at 122. Dynamic code generator 116 is in communication with pump controller 112. In one example, dynamic code generator 116 is part of pump controller 112. In other examples, dynamic code generator 116 is separate from pump controller 112.

In examples, data log 110, pump controller 112, and display 114 are located on the same control panel 124. Both data log 110 and display 114 can be located on controller 112. Data log 110 and display 114 can be located separate from pump controller 112, but in the same control panel. In other examples, at least one of data log 110 and display 114 can be located separate from pump controller 112 and separate from control panel 124.

Sensors 126 aid in monitoring a pump system. Sensors 126 include sensors located on or within a pump, and sensors located near the pump but external to the pump for monitoring the pump system. Sensors 126 are in communication with pump controller 112, indicated at 128. Sensors 126 provide sensor data (e.g., sensor and alarm data) to control panel 124. Sensor data is provided to pump monitoring and control system 100 via pump controller 112 and stored in data log 110, indicated as sensor data 130. Additionally, pump controller 112 provides control outputs 134. The control outputs 134 can be provided to the pump monitoring system pump for controlling operation of the pump (e.g., pump start, pump run, pump stop). Control outputs 134 can also be provided for operation of various other pump system devices.

In operation, the pump controller 112 receives pump sensor data 130 from sensors 126. The pump sensor data 130 is stored in the data log 110. Upon receiving a data request, the dynamic code generator 116 dynamically generates a code 140 representative of the pump sensor data 130 stored in data log 110. Code 140 is a visible (i.e., readable) code. In another example, code can also be immediately generated upon occurrence of a predefined event, such as an alarm or device fail condition without the need for a data request. The code is representative of the event (e.g., information related to an alarm condition or device fail condition, etc.).

Code examples include single or multidimensional codes. An example single dimensional code is a bar code or numerical code. Multidimensional codes (e.g., 2D or 3D codes) store data across both horizontal and vertical dimensions and are capable of storing large amounts of data within the visual code. In one example, code 140 is a Quick Response (QR) code.

Upon receiving the data request, the dynamically generated code 140 is output to the pump display 114. The dynamically generated code 140 is a visual code and is readable by display reader 142. In examples, display reader 142 is a mobile code reader, mobile phone, tablet or other devices capable of scanning the display code 140 and reading the information contained within the code 140.

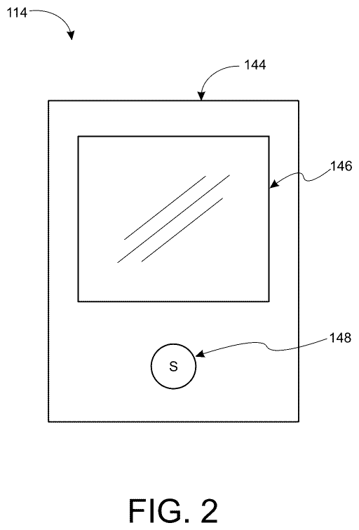

FIG. 2 is a diagram illustrating one example of display 114 for use with the pump monitoring system 100 illustrated in FIG. 1. Display 114 includes a display body 144, a display screen 146, and user interface 148. In one example, user interface 148 is a selector switch. User interface 148 provides a user input to dynamic code generator 116. Upon operation of the user interface 148, dynamic code generator 116 operates to generate code 140 representative of pump sensor data stored in the data log. In another example, a code can also be immediately generated upon occurrence of a predefined event, such as an alarm or device fail condition without the need for a data request. Code 140 is then output to display 114, and visually displayed on display screen 146. User interface 148 can be part of display 114 as illustrated or the user interface 148 can be separate from display 114. In another embodiment, user interface is located on control panel 124 adjacent to pump controller 112. User interface 148 can also be a remote device, such as a mobile phone or tablet, and communicate with pump controller 112 via a wireless communication link (e.g., blue tooth, BLE, etc.).

In one specific example, the code 140 is a QR code. QR codes are two dimensional bar codes capable of storing larger amounts of data relative to other codes, using a grid of black and white squares. QR codes store information both horizontally and vertically, allowing them to hold much more data. The basic structure of a QR code contains several functional areas. Finder patterns consisting of three large squares located in the corners provide code position detection. These patterns help scanners detect orientation, and allow for instant recognition of code boundaries. Alignment patterns are provided as smaller square patterns. Timing patterns are provided in alternating black and white modules. Quiet zones exist as white space surrounding the code. Data modules in the form of black and white squares are provided. The data modules contain the encoded data monitoring (e.g., sensor data, data timing log) information.

Other multidimensional codes can be generated that are visually representative of logged data. Those codes include, for example, data matrix codes, PDF codes, Aztec Codes MaxiCodes or multidimensional tags.

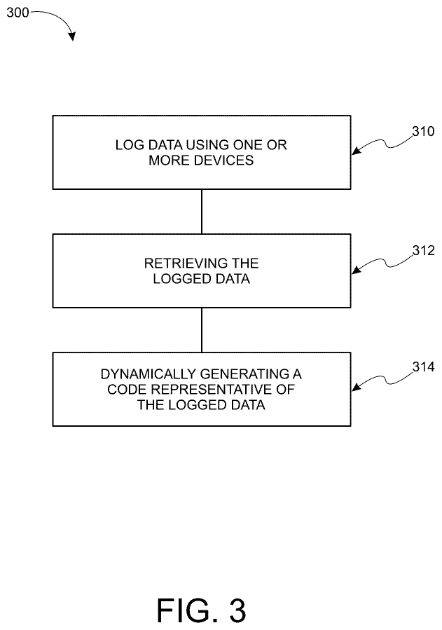

FIG. 3 is a diagram illustrating one example of a method of retrieving logged data from a pump monitoring system generally at 300. At 310, data is logged using one or more devices. The devices can include sensors located on or within a pump, and sensors located near the pump but external to the pump for monitoring the pump system. In one example, pump sensors include a pump high temperature switch or pump seal leak sensors (e.g., seal leak sensing probes). Example external pump sensors can include a submersible pressure sensor, a high water float switch, or a low water float switch.

At 312, the logged data is retrieved. In one example, upon receiving a request (e.g., via a user interface) the logged data is retrieved from the data log on the control panel. The retrieved data is provided to a dynamic code generator. At 314, the system provides for dynamically generating a code representative of the logged data. In one example, the code is a multi-dimensional code. In one specific example, the code is a two dimensional QR code.

In another example, code can also be immediately generated upon occurrence of a predefined event, such as an alarm or device fail condition without the need for a data request.

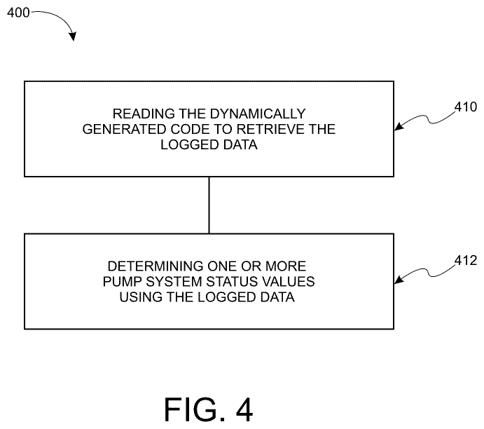

FIG. 4 is a diagram illustrating one example of the method of FIG. 3, generally at 400. At 410, the system includes reading the dynamically generated code to retrieve the logged data. In operation, the dynamically generated code is a visual code that is provided to the display 114. A display reader 142 is operable to read the visual code. At 412, the method includes determining one or more pump system status values using the logged data.

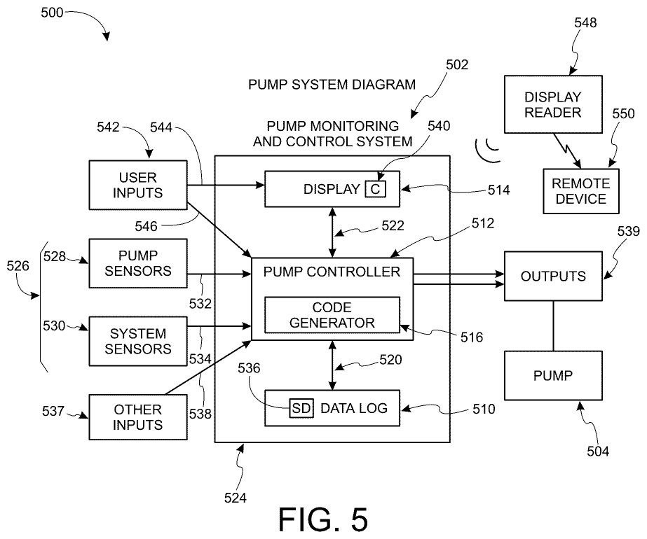

FIG. 5 is a diagram illustrating one example of a pump system diagram 500, including a pump monitoring and control system having a dynamic code generator illustrated at 502. In one example, the pump monitoring and control system 502 is a submersible pump monitoring and control system. Pump monitoring and control system 502 can be similar to the pump monitoring and control system 100 previously detailed herein. Although the pump monitoring and control system 502 as detailed herein may be referred to as a pump monitoring system, it is recognized that the system 502 may be a pump monitoring system, a pump control system, or both a pump monitoring system and a pump control system. Pump monitoring and control system 502 is illustrated as part of pump system diagram 500, and in one example, monitors the pump system for submersible pump 504.

The pump monitoring system 502 includes a data log 510, a pump controller 512, and a display 514. The pump controller 512 further includes a code generator 516. Code generator 516 is a dynamic code generator. As a dynamic code generator, the code generator immediately generates a code representative of the present status of logged data. In one or more examples, the pump controller 512 is a programmable controller. The data log 510 is in communication with the pump controller 512, indicated at 520. Display 514 is in communication with the pump controller 512, indicated at 522. Dynamic code generator 516 is in communication with pump controller 512. In one example, dynamic code generator 516 is part of pump controller 512. In other examples, dynamic code generator 516 is separate from pump controller 512.

In examples, data log 510, pump controller 512, and display 514 are located on the same control panel 524. Both data log 510 and display 514 can be located on controller 512. Data log 510 and display 514 can be located separate from pump controller 512, but in the same control panel. In other examples, at least one of data log 510 and display 514 can be located separate from pump controller 512 and separate from control panel 524. One or more examples of display 514 are detailed further in this specification.

Sensors 526 aid in monitoring a submersible pump 504. Sensors 526 include pump sensors 528 located on or within the submersible pump 504, and system sensors 530 located near the submersible pump 504 but external to the submersible pump 504 for monitoring the pump system. Sensors 526 are in communication with pump controller 512. In one example illustrated, pump sensors 528 are in communication with pump controller 512, indicated at 532. System sensors 530 are in communication with pump controller 512, indicated at 534. Sensors 526 provide sensor data to control panel 524. Sensor data is provided to pump monitoring and control system 502 via pump controller 512 and stored in data log 510, indicated as sensor data 536. Other inputs 537 (e.g., alarms, etc) are also provided to pump controller 512, indicated at 538. Additionally, pump controller 512 provides control outputs 538. The control outputs 538 can be provided to the submersible pump 506 for controlling operation (e.g., pump start, pump run, pump stop, etc.) of the submersible pump 506. Control outputs 538 can also be provided for operation of various other pump system devices (e.g., pump alarms, pump visual indicators, etc.).

In operation, the pump controller 512 receives pump sensor data 536 from sensors 526. The pump sensor data 536 is stored in data log 510. Upon receiving a data request, the dynamic code generator 516 dynamically generates a code 540 representative of the pump sensor data 536 stored in data log 510. Code 540 is a readable code. In one example, code 540 is a QR code.

In another example, code can also be immediately dynamically generated upon occurrence of a predefined event, such as an alarm or device fail condition without the need for a data request.

User inputs 542 provide user requests to controller 512. In examples, user inputs 542 provide requests to controller 512 through display 514, indicated at 544, or directly to pump controller 512, indicated at 546.

Code examples include single or multidimensional codes. An example single dimensional code is a bar code or numerical code. Multidimensional codes (e.g., 2D or 3D codes) store data across both horizontal and vertical dimensions and are capable of storing large amounts of data within the visual code. In one example, the code is a two dimensional code identified as a QR code.

In one example, upon receiving the data request, the dynamically generated code 540 is output to the pump display 514. The dynamically generated code 540 is a visual code and is readable by display reader 548. In examples, display reader 542 is a mobile code reader, mobile phone, or tablet capable of scanning the display code 540 and reading the information contained within the code 540. In one example, display reader 540 includes a QR reader application for scanning (i.e., reading) a dynamically generated QR code displayed on pump display 514. Display reader 540 can transfer a copy of the QR code to remote device 550, and remote device 550 retrieves the logged data information from the QR code. Alternatively, display reader 540 immediately retrieves the logged data from the read (i.e., scanned) QR code and stores the retrieved logged data on the remote device 550. Display reader 548 wirelessly couples (e.g., via cellular, blue tooth, BLE, a wireless network, etc.) to the remote device 550 to transfer the retrieved logged data between the display reader 548 and remote device 550.

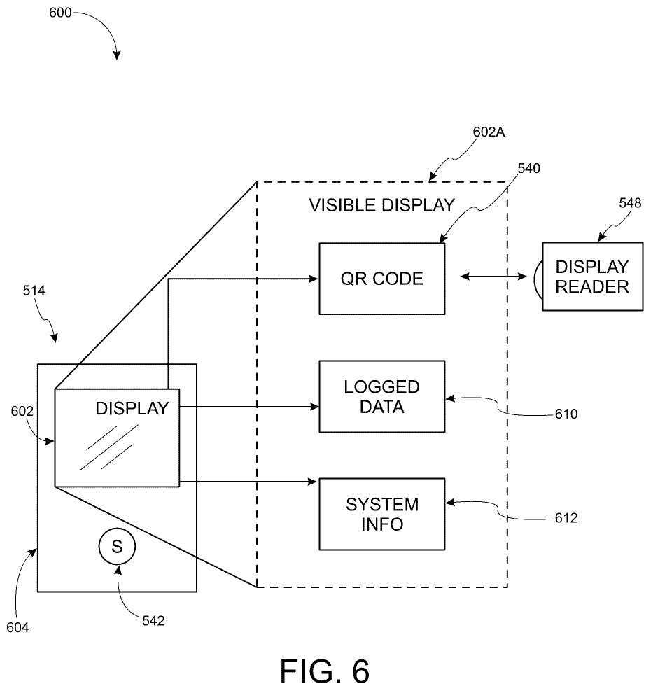

FIG. 6 is a diagram illustrating one example of display 514 used in the pump monitoring system of FIG. 5, indicated at 600. Display 514 includes a display body 604, a display screen 602, and user interface 542. In one example, user interface 542 is a selector switch. User interface 542 provides a user input to dynamic code generator 516. In one example, user interface 542 provides a user input to dynamic code generator 516 via programmable pump controller 512. Upon operation of the user interface 542, dynamic code generator 516 operates to generate code 540 representative of pump sensor data stored in the data log. Code 540 is then output to display 514 and visually displayed on display screen 602. User interface 542 can be part of display 514 as illustrated or the user interface 542 can be separate from display 114. In another embodiment, user interface is located on control panel 524 adjacent to pump controller 512. User interface 542 can also be a remote device, such as a mobile phone or tablet, and communicate with pump controller 112 via a wireless communication link (e.g., blue tooth, BLE, etc.).

One example of display screen 602 is illustrated in an enlarged view as visible display screen 602A. Visible display screen 602A is capable of displaying multiple display views with different types of information. In the example illustrated, visible display screen 602A is operable to display visible code 540 shown as a QR code.

The code 540 is a readable code, and capable of being read by display reader 548 as detailed herein. The visible display screen is capable of displaying other types of information, including other forms of logged information or system information. In the example illustrated, visible display screen 602A can also display logged data 610 and system information 612. User input 542 is a switch that is operable to change what is displayed on the display screen 602A between QR code 540, logged data 610, and system information 612.

In one example, user input 542 is a selector switch. By operating the selector switch, a user can move between desired screen displays on the visible display screen 602A. Operation of user input 542 provides an input request to pump controller 512. Pump controller 512 provides a corresponding output to visible display screen 602A. For example, a user can operate user input 542 to select and view system information 612 on the visible display screen 602A. A user can operate user input 542 to select and view logged data 610 on the visible display screen 602A. A user can operate user input 542 to select and view QR code 540 on the visible display screen 602A. The QR code 540 can then be read using display reader 548, allowing a user to obtain logged data from the pump monitoring system 502.

In another example, a code (e.g., a QR code) can also be immediately dynamically generated and displayed on display screen 602A upon occurrence of a defined event, such as an alarm or device fail condition without the need for a data request. The displayed code contains necessary information about the defined event and is readable by a display reader.

In one specific example, the code 540 is a QR code. QR codes are two dimensional bar codes capable of storing larger amounts of data relative to other codes, using a grid of black and white squares. QR codes store information both horizontally and vertically, allowing them to hold much more data. The basic structure of a QR code contains several functional areas. Finder patterns consisting of three large squares located in the corners provide code position detection. These patterns help scanners detect orientation, and allow for instant recognition of code boundaries. Alignment patterns are provided as smaller square patterns. Timing patterns are provided in alternating black and white modules. Quiet zones exist as white space surrounding the code. Data modules in the form of black and white squares are provided. The data modules contain the encoded data monitoring (e.g., sensor data, data timing log) information.

Other multidimensional codes can be generated that are visually representative of logged data. Those codes include, for example, data matrix codes, PDF codes, Aztec Codes MaxiCodes or multidimensional tags.

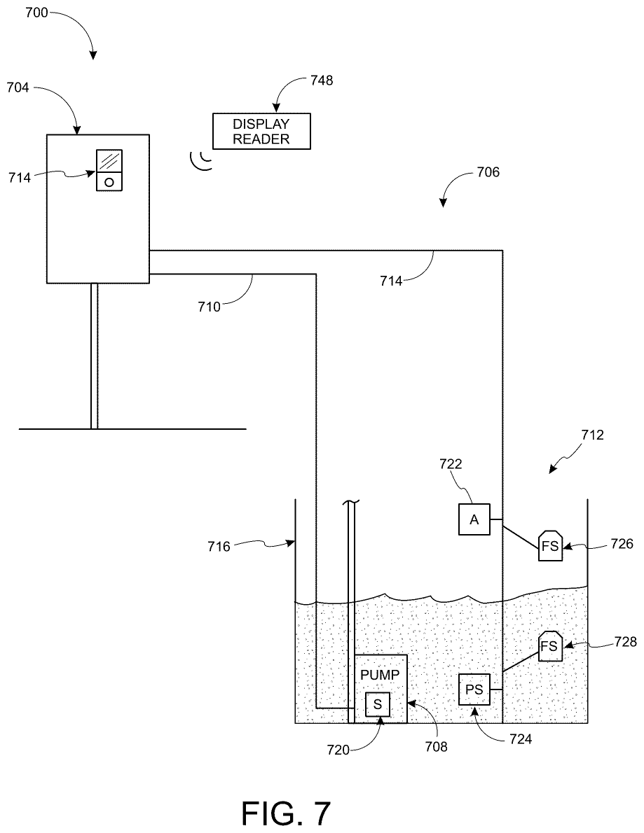

FIG. 7 is a diagram illustrating one example of a submersible pump installation including a pump monitoring and control system, indicated at 700. The pump monitoring and control system 700 is similar to the pump monitoring and control systems previously detailed herein. The pump monitoring and control system illustrated is a submersible pump system.

The pump monitoring and control system 700 includes a control panel 704 and submersible pump system 706, including submersible pump 708. Power and control connections (e.g., wiring cables) are routed between control panel 704 and pump 708, indicated at 710. Power and control wiring is also routed between control panel 704 and system sensors and alarms 712, indicated at 714.

Control panel 704 is similar to the control panels previously detailed herein. Control panel 704 is mounted above the submersible pump system 706, where it is accessible by pump system personnel. In one example, control panel 704 is mounted directly above (i.e., above grade) submersible pump system 706, where the submersible pump system is accessible via access covers as known in the art. In other examples, control panel 704 is mounted away from the submersible pump system in an accessible area.

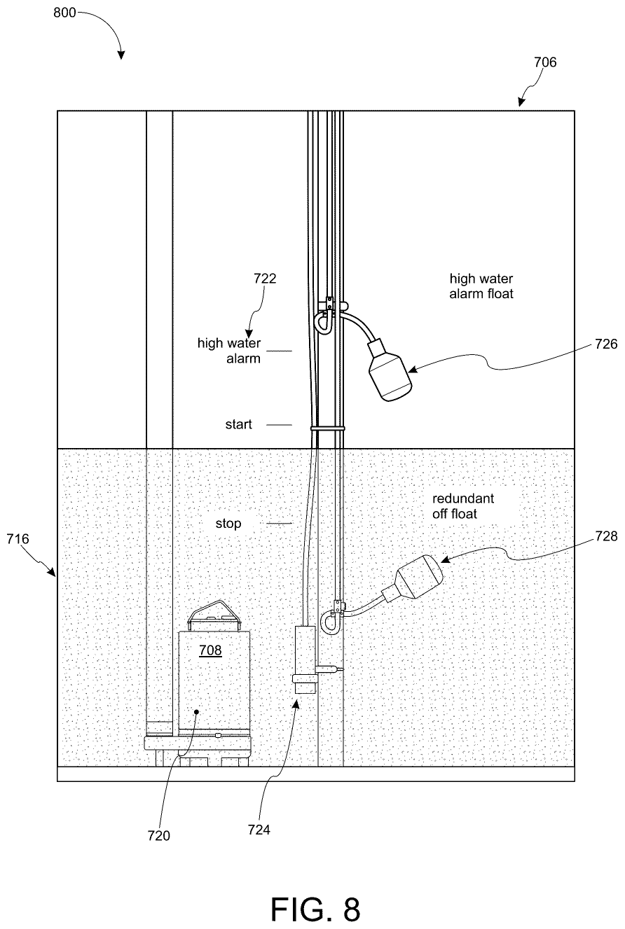

The submersible pump system 706 is installed in a tank 716 below grade (e.g., a buried tank) and includes pump 708 with pump sensors 720, and system sensors and alarms 712. In one example illustrated, the system sensors and alarms include alarm 722, pressure sensor 724, float switch 726 and float switch 728. In examples, high water alarm 722 can be a physical high water alarm, or an alarm level monitored using pressure sensor 714 or float switch 726. FIG. 8 is a diagram illustrating in further detail one example of the submersible pump system 706 installation, indicated at 800.

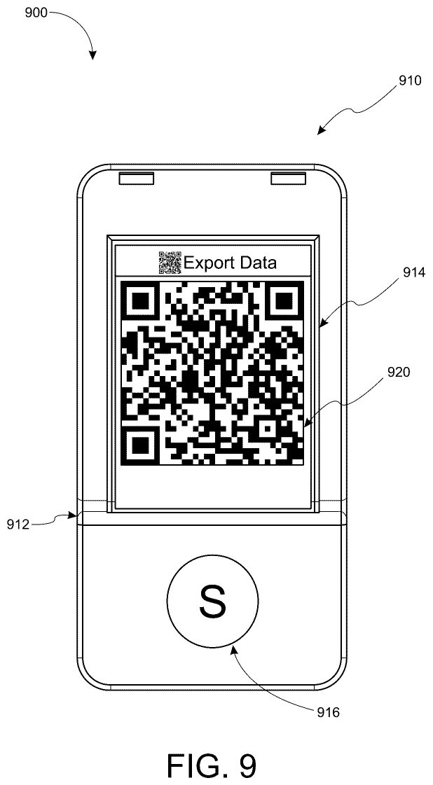

FIG. 9 is a diagram 900 illustrating one example of a display 910 used in a pump monitoring system. The display 900 includes one example of a display body 912, a display screen 914, and user input 916. Examples of the display body 912, a display screen 914, and user input 916 have been previously detailed herein. The display screen 914 includes QR code 920. The QR code 920 is a multidimensional visible code representative of sensor, alarm or system pump data using submersible pump system 706.

QR codes are two-dimensional bar codes capable of storing larger amounts of data relative to other codes, using a grid of black and white squares. QR codes store information both horizontally and vertically, allowing them to hold much more data. The basic structure of a QR code contains several functional areas. Finder patterns consisting of three large squares located in the corners provide code position detection. These patterns help scanners detect orientation, and allow for instant recognition of code boundaries. Alignment patterns are provided as smaller square patterns. Timing patterns are provided in alternating black and white modules. Quiet zones exist as white space surrounding the code. Data modules in the form of black and white squares are provided. The data modules contain the encoded data monitoring (e.g., sensor data, data timing log) information.

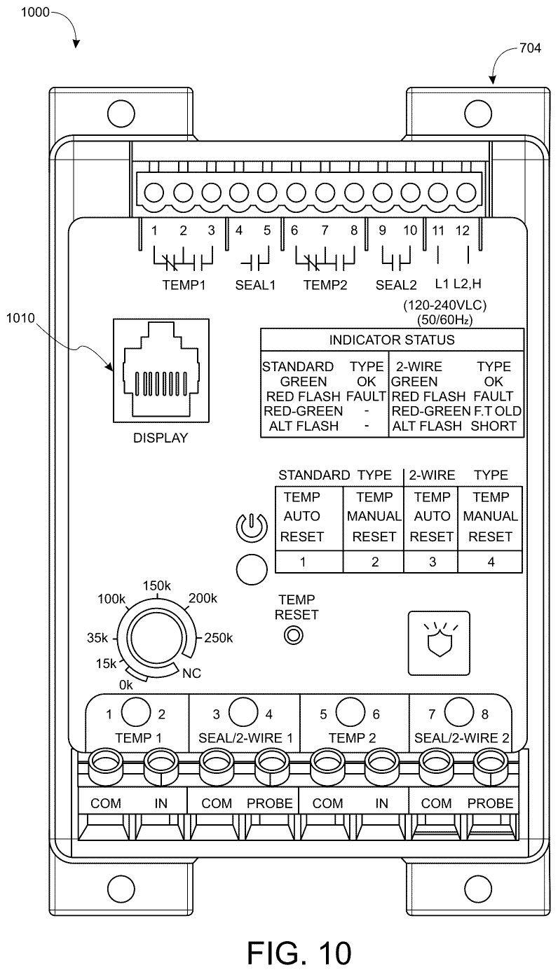

FIG. 10 is a diagram 1000 illustrating a physical representation of one example of a control panel used in a pump and control system monitoring system, indicated at 704. The control panel 704 includes sensor wire and cable terminations, status indicators, reset buttons, and local control switches that interface the submersible pump installation with control panel 704 and the controller contained therein. In one example illustrated, the pump display is a mobile display, and removably couples to control panel 704 at display connector 1010.

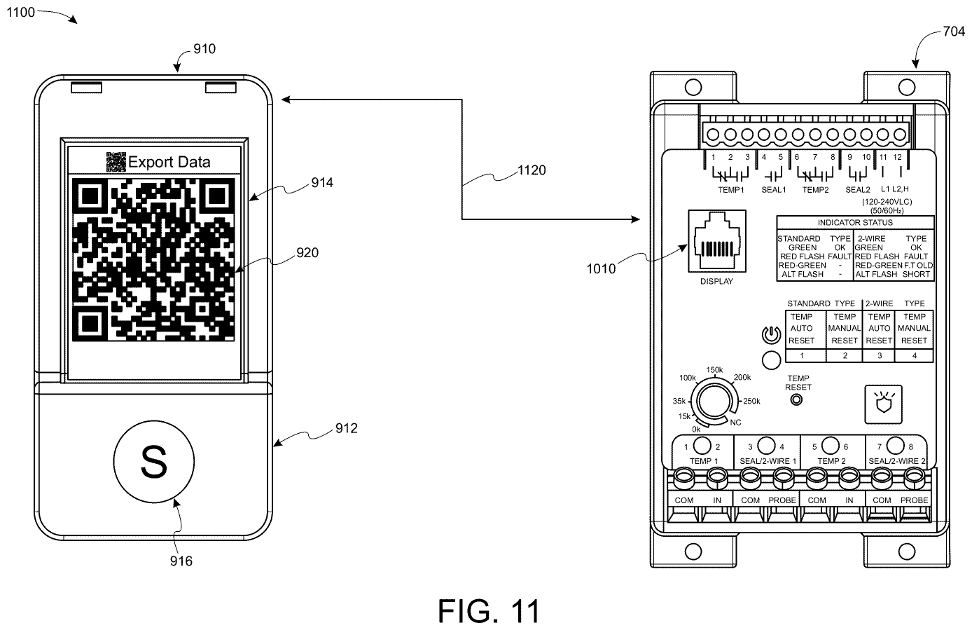

FIG. 11 is a diagram illustrating one example of a removable display in communication with the controller of FIG. 10, indicated at 1100. Display 910 is a mobile display. In operation, display 910 is coupled to control panel 704 at display connector 1010 using cable 1120. This allows the same display to be used for multiple control panels. When retrieving pump system logged data, a system operator simply connects the removable display 910 to the control panel 704 at display connector 1010. Once the logged data is retrieved and downloaded using a display reader (e.g., reading the dynamically generated QR code using a mobile phone), the display 910 is removed. The display 910 can be taken to another pump control panel in another pump installation location, and be used to access and download logged pump data a that location. As such, a single display device can be used for downloading logged data at multiple pump locations.

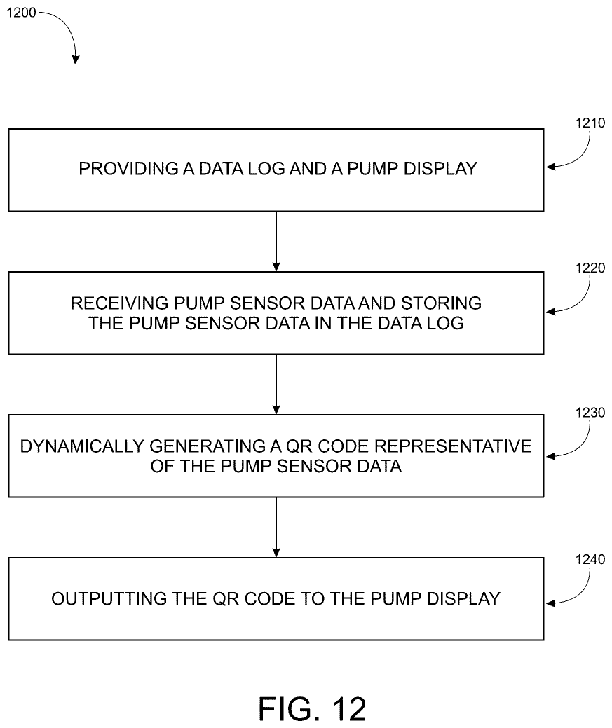

FIG. 12 is a diagram illustrating one example of a method of retrieving logged data from a pump monitoring system, indicated at 1200. At 1210, a data log and a pump display are provided. At 1220, the method includes receiving pump sensor data and storing the pump sensor data in the data log. At 1230, the method includes dynamically generating a QR code representative of the pump sensor data. The code may be generated concurrently with storage of the sensor data (e.g., sensor and alarm data). At 1240, the method includes outputting the QR code to the pump display. The QR code can now be read and the logged data downloaded using a code display reader.

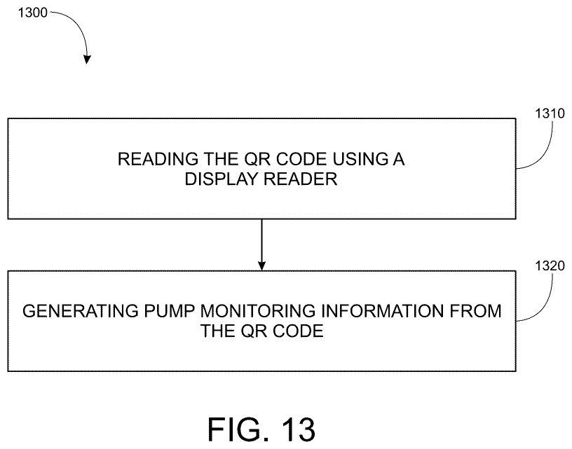

FIG. 13 is a diagram illustrating one example of a method of retrieving logged data from a pump monitoring system, indicated at 1300. At 1310, the method includes reading the QR code using a display reader. The QR code is representative of logged pump data. At 1320, the method includes generating pump monitoring information from the QR code. In one example, the QR code is read and saved by the display reader and subsequently the QR code is downloaded to a remote device. The logged data is then accessed and retrieved using the remote device. In another example, the QR code is read and the logged data is retrieved by the display reader.

It is to be understood that the features of the various exemplary embodiments described herein may be combined with each other, unless specifically noted otherwise.

### EXAMPLES

In the following, pump monitoring and control systems, pump monitoring systems, submersible pump systems and associated methods in accordance with the disclosure are described by means of examples.

Example 1 is a pump monitoring and control systems comprising: a data log; a pump controller that receives pump sensor data and stores the pump sensor data in the data log; and a dynamic code generator that upon receiving a data request, dynamically generates a code representative of the pump sensor data stored in the data log, where the code is a readable code.

Example 2 is the submersible pump system of claim 1, where the dynamic code generator is separate from the pump controller.

Example 3 is the submersible pump system of claim 1, where the code is a multidimensional code.

Example 4 is the submersible pump system of claim 3, where the code is a visual code readable by an external device.

Example 5 is the submersible pump system of claim 3, where the code is a visible QR code.

Example 6 is the submersible pump system of claim 3, further comprising a display, where the code is output to the display.

Example 7 is the submersible pump system of claim 6, comprising a user interface in communication with the pump controller, where the data request is provided to the pump controller via the user interface.

Example 8 is the submersible pump of claim 1, comprising: a pump sensor that inputs the pump sensor data to the pump controller.

Example 9 is the submersible pump of claim 1, where the pump controller provides control outputs to a submersible pump based on the pump sensor data or the user interface.

Example 10 is a submersible pump system comprising: a data log; a pump display; a pump controller that receives pump sensor data and stores the pump sensor data in the data log; a dynamic code generator that upon receiving a data request, dynamically generates a QR code representative of the pump sensor data stored in the data log, and outputs the QR code to the pump display.

Example 11 is the submersible pump system of claim 10, where the dynamic code generator is separate from the pump controller.

Example 12 is the submersible pump system of claim 10, where the QR code is output to the pump display via the pump controller.

Example 13 is the submersible pump system of claim 10, where the pump display is a removable display device.

Example 14 is the submersible pump system of claim 10, comprising a user interface in communication with the pump controller, where the data request is provided to the pump controller via the user interface.

Example 15 is the submersible pump system of claim 14, where the user interface comprises a mechanical selector switch.

Example 16 is the submersible pump system of claim 14, where the user interface communicates with the pump controller via a wireless communication link.

Example 17 is the submersible pump system of claim 10, comprising a pump sensor that inputs the pump sensor data to the pump controller, and a system sensor that inputs system sensor data to the pump controller.

Example 18 is the submersible pump system of claim 1, comprising a submersible pump, where the pump controller provides control outputs to the submersible pump based on the pump sensor data and the system sensor data.

Example 19 is a method retrieving submersible pump system data comprising: providing a data log and a pump display; receiving pump sensor data and storing the pump sensor data in the data log; dynamically generating a QR code representative of the pump sensor data stored in the data log and outputting the QR code to the pump display.

Example 20 is the method of claim 19 comprising: reading the QR code using a display reader; and generating pump monitoring information from the QR code.

It is to be understood that the features of the various exemplary embodiments described herein may be combined with each other, unless specifically noted otherwise.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

The following claims are part of the specification.

What is claimed is:

1. A submersible pump system comprising:
a data log;
a pump controller that receives pump sensor data and stores the pump sensor data in the data log; and
a dynamic code generator that upon receiving a data request, dynamically generates a code representative of the pump sensor data stored in the data log, where the code is a readable code.

2. The submersible pump system of claim 1, where the dynamic code generator is separate from the pump controller.

3. The submersible pump system of claim 1, where the code is a multidimensional code.

4. The submersible pump system of claim 3, where the code is a visual code readable by an external device.

5. The submersible pump system of claim 3, where the code is a visible QR code.

6. The submersible pump system of claim 3, further comprising a display, where the code is output to the display.

7. The submersible pump system of claim 6, comprising a user interface in communication with the pump controller, where the data request is provided to the pump controller via the user interface.

8. The submersible pump of claim 1, comprising: a pump sensor that inputs the pump sensor data to the pump controller.

9. The submersible pump of claim 1, where the pump controller provides control outputs to a submersible pump based on the pump sensor data or the user interface.

10. A submersible pump system comprising:
a data log;
a pump display;
a pump controller that receives pump sensor data and stores the pump sensor data in the data log;
a dynamic code generator that upon receiving a data request or occurrence of a defined event, dynamically generates a QR code representative of the pump sensor data stored in the data log, and outputs the QR code to the pump display.

11. The submersible pump system of claim 10, where the dynamic code generator is separate from the pump controller.

12. The submersible pump system of claim 10, where the QR code is output to the pump display via the pump controller.

13. The submersible pump system of claim 10, where the pump display is a removable display device.

14. The submersible pump system of claim 10, comprising a user interface in communication with the pump controller, where the data request is provided to the pump controller via the user interface.

15. The submersible pump system of claim 14, where the user interface comprises a mechanical selector switch.

16. The submersible pump system of claim 14, where the user interface communicates with the pump controller via a wireless communication link.

17. The submersible pump system of claim 10, comprising a pump sensor that inputs the pump sensor data to the pump controller, and a system sensor that inputs system sensor data to the pump controller.

18. The submersible pump system of claim 10, comprising a submersible pump, where the pump controller provides control outputs to the submersible pump based on the pump sensor data and the system sensor data.

19. The submersible pump system of claim 10, where the defined event comprises one of an alarm condition or system fail condition.

20. A method retrieving submersible pump system data comprising:
providing a data log and a pump display;
receiving pump sensor data and storing the pump sensor data in the data log
dynamically generating a QR code representative of the pump sensor data stored in the data log, and outputting the QR code to the pump display.
